(19) United States
(12) Patent Application Publication
(10) Pub. No.: US 2005/0129978 A1
(43) Pub. Date: Jun. 16, 2005

(54) Electroluminescent device and method of manufacturing thereof

(75) Inventors: Harue Nakashima, Atsugi (JP); Satoshi Seo, Kawasaki (JP)

Correspondence Address: NIXON PEABODY, LLP, 401 9TH STREET, NW, SUITE 900, WASHINGTON, DC, 20004-2128, US

(73) Assignee: Semiconductor Energy Laboratory Co., Ltd., Atsugi-shi (JP)

(21) Appl. No.: 10/736,329

(22) Filed: Dec. 16, 2003

(30) Foreign Application Priority Data
Dec. 25, 2002 (JP) 2002-374022

(51) Int. Cl. H05B 33/14

(52) U.S. Cl. 428/690; 428/917; 313/504; 427/66

(57) ABSTRACT

The present invention is having a characteristic of, even for a material for which deposition or wet coating is difficult in a state of a metal complex, co-deposition an organic compound (ligand) and a metal salt constituting raw materials of the metal complex to execute complex formation on a substrate thereby forming a film containing such metal complex and preparing an electroluminescent device utilizing thus formed co-decomposition film. The aforementioned organic compound (ligand) is required to have a functional group easily releasing a proton to show anionic property (thus bonding with a metal), and a functional group having a non-covalent electron pair for coordination bonding with a metal.

### TECHNICAL FIELD

The present invention relates to an electroluminescent device provided with an electroluminescent layer sandwiched between a pair of electrodes, and a light emitting device utilizing the aforementioned electroluminescent layer. Also it relates to a manufacturing method for the aforementioned electroluminescent device.

### BACKGROUND ART

An electroluminescent device utilizing an organic compound as a light emitter has characteristics of thin and light, high-speed response, low DC voltage drive, a wide viewing angle and the like, and is attracting attention as a flat panel display element of next generation.

A light emitting mechanism of the electroluminescent device is considered that, upon application of a voltage to the electroluminescent layer sandwiched between a pair of electrodes, electrons and holes as carriers are respectively injected from a cathode and an anode, and these recombine at a light emitting center in the electroluminescent layer to form molecular excitons which release energy as light when returning to a ground state. The excited state is known in a singlet state and a triplet state, but the light emitting is considered possible from either state.

Since the light emission of the electroluminescent layer relies on injection and recombination of the carriers, a well-balanced injection of the electrons and the holes is a key to a higher efficiency. For this purpose the electroluminescent layer constituting the recombination area of the carriers is preferably not formed by a single layer but by a structure with layers divided by functions, such as a light emission layer, an electron injection layer, an electron transport layer, a hole transport layer, a hole injection layer and the like. Also presence of a layer between the light emitting layer and the electrode is preferable in that extinction of the molecular exciton by the electrode interface can be prevented.

Currently, in case of forming the electroluminescent layer with a polymer material, a film is formed by a wet process such as spin coating method or ink jet method. Since a layer lamination is difficult with the wet process, other processes suitable for layer lamination are also tried, but deposition is considered impossible for the polymer material because of the magnitude of the molecular weight thereof. In order to overcome this point, there is being tried a method of co-depositing one or more low-molecular materials (monomers) constituting raw materials thereof and conducting a treatment such as heating in vacuum to execute polymerization on the substrate thereby forming a film (for example cf. M. Jandke et al., Synthetic Metals, 111-112 (2000) page 221-223 and JAPANESE PATENT Laid-Open No. 2000-150148).

On the other hand, film formation of a low-molecular material is principally executed by vacuum deposition. Particularly a metal complex provides a satisfactory film quality in the deposition film, because of a high amorphous property. However, substances that can be deposited are currently limited, such as copper phthalocyanine (hereinafter represented as CuPc) or tris(8-quinolilato)aluminum (hereinafter represented as Alq). Most substances have a high evaporation temperature and are decomposed before evaporation.

For example, it is reported that a metal complex not satisfying the coordination number of the metal center is difficult to deposit under vacuum even if it has satisfactory light emitting characteristics and is unsuitable for the electroluminescent device (for example, cf, Y. Hamada, IEEE TRANSACTIONS ON ELECTRON DEVICES, Vol. 44, No. 8(1997) page 1208-1217). For such substance that is difficult to deposit, a film formation by deposition is naturally not possible and other approaches such as spin coating by introduction into a polymer (for example, cf, U.S. Pat. No. 5,529,853). However, such metal complexes are generally poor in solubility.

Some metal complex materials, even among those poor in sublimability or solubility, show satisfactory physical properties such as thermal stability or fluorescent intensity and are anticipated to provide very good characteristics when applied to the electroluminescent device. Therefore, a film forming method not relying on the prior technologies is desired.

### DISCLOSURE OF THE INVENTION

(Problem for Solving the Invention)

In view of the foregoing problem, it is an object of the present invention is to provide means allowing, even for a material difficult to deposit or to coat in a wet process in a complex state, to form a thin film including such complex, and to provide an electroluminescent device prepared with such means.

(Means for Solving the Problem)

Complex materials easy to deposit or to coat by a wet process are limited, but ligands or metal salts as raw materials of such complexes are often relatively easily deposited. The present inventor has therefore conceived to co-deposit a ligand and a metal salt which are raw materials of a metal complex essentially, thereby forming a complex on a substrate and obtaining a film containing such metal complex. It has also be conceived to prepare an electroluminescent device, utilizing such co-deposition film.

A metal complex employed in an electroluminescent device is, as represented by Alq, principally a metal complex having an anionic chelate ligand. Such ligand is characterized in having a functional group capable of easily releasing a proton thereby showing an anionic property (thus bonding with a metal), and a functional group having a non-covalent electron pair for coordination bonding with a metal. Thus, in the present invention, an organic compound (ligand) to be co-evaporated with a metal salt is required to have at least one each of the aforementioned two functional groups.

Therefore, the present invention relates to an electroluminescent device including at least an anode, a cathode and an electroluminescent layer provided between the anode and the cathode, and having a characteristic of the electroluminescent layer includes a layer formed by co-deposition of an organic compound and a metal salt, and the organic compound includes at least one each of a proton-donating functional group showing Bronsted acid and a functional group having a non-covalent electron pair.

The aforementioned proton-donating functional group is preferably any functional group selected from a group of a hydroxyl group, a carboxyl group and a mercapto group. Also the aforementioned functional group having the non-covalent electron pair is preferably any functional group selected from a group of a heterocyclic residue group, an azomethine group and a carbonyl group. It is also effective to utilize such proton-donating functional groups and such functional groups having the non-covalent electron pair respectively in combination.

On the other hand, the aforementioned metal salt is preferably any one selected from a group of a metal acetate salt, a metal halide and a metal alkoxide.

As the aforementioned organic compound having at least one each of the proton-donating functional group showing Bronsted acid and the functional group having non-covalent electron pair is advantageously an organic compound represented by following general formulas (1)-(5). The present invention, therefore, relates to an electroluminescent device including at least an anode, a cathode and an electroluminescent layer provided between the anode and the cathode, and is having a characteristic of the electroluminescent layer includes a layer formed by co-deposition of an organic compound and a metal salt, and the organic compound is a compound represented by any of following general formulas (1)-(5):

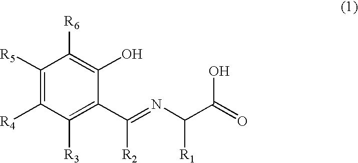

In the general formula (1), R1-R6 each represents a hydrogen element, a halogen element, a cyano group, an alkyl group (however limited to 1-10 carbon atoms), an alkoxyl group (however limited to 1-10 carbon atoms), a substituted or non-substituted aryl group (however limited to 1-20 carbon atoms), or a substituted or non-substituted heterocyclic residue group (however limited to 1-20 carbon atoms). And R3 and R4, R4 and R5 or R5 and R6 may be mutually bonded to form a benzene ring or poly-condensed rings (however limited to 1-20 carbon atoms). And R1 and R2 may be mutually bonded to form a pyridine ring.

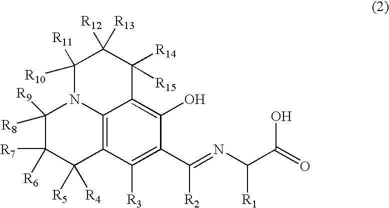

In the general formula (2), R1-R15 each represents a hydrogen element, a halogen element, a cyano group, an alkyl group (however limited to 1-10 carbon atoms), an alkoxyl group (however limited to 1-10 carbon atoms), a substituted or non-substituted aryl group (however limited to 1-20 carbon atoms), or a substituted or non-substituted heterocyclic residue group (however limited to 1-20 carbon atoms). And R1 and R2 may be mutually bonded to form a pyridine ring.

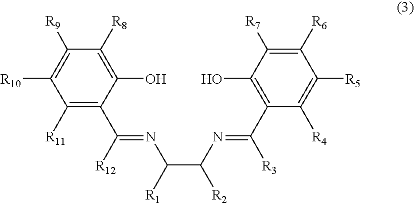

In the general formula (3), R1-R12 each represents a hydrogen element, a halogen element, a cyano group, an alkyl group (however limited to 1-10 carbon atoms), an alkoxyl group (however limited to 1-10 carbon atoms), a substituted or non-substituted aryl group (however limited to 1-20 carbon atoms), or a substituted or non-substituted heterocyclic residue group (however limited to 1-20 carbon atoms); R1 and R2 may be mutually bonded to form a cycloalkane structure, a benzene ring or poly-condensed rings (however limited to 1 to 20 carbon atoms). And R4 and R5, R5 and R6, R6 and R7, R8 and R9, R9 and R10 or R10 and R11 may be mutually bonded to form a benzene ring or poly-condensed rings (however limited to 1-20 carbon atoms). And R2 and R3 or R1 and R12 may be mutually bonded to form a

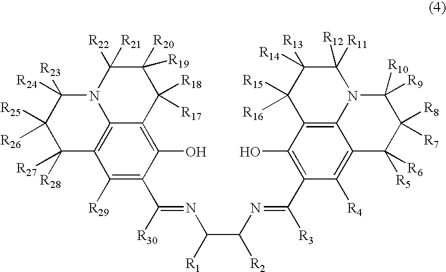

In the general formula (4), R1-R30 each represents a hydrogen element, a halogen element, a cyano group, an alkyl group (however limited to 1-10 carbon atoms), an alkoxyl group (however limited to 1-10 carbon atoms), a substituted or non-substituted aryl group (however limited to 1-20 carbon atoms), or a substituted or non-substituted heterocyclic residue group (however limited to 1-20 carbon atoms). And R1 and R2 may be mutually bonded to form a cycloalkane structure, a benzene ring or poly-condensed rings (however limited to 1 to 20 carbon atoms). And R2 and R3 or R1 and R30 may be mutually bonded to form a pyridine ring.

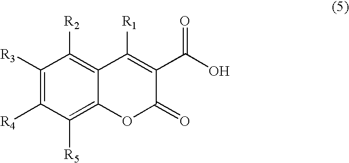

In the general formula (5), R1-R5 each represents a hydrogen element, a halogen element, a cyano group, an alkyl group (however limited to 1-10 carbon atoms), an alkoxyl group (however limited to 1-10 carbon atoms), a substituted or non-substituted aryl group (however limited to 1-20 carbon atoms), or a substituted or non-substituted heterocyclic residue group (however limited to 1-20 carbon atoms). And R4 may represent any of an amino group, a dialkylamino group, and an arylamino group. And R2 and R3, R3 and R4 or R4 and R5 may be mutually bonded to form a benzene ring or poly-condensed rings (however limited to 1 to 20 carbon atoms). And R3 and R4 or R4 and R5 may be mutually bonded to form a julolidine skeleton.

The metal salt to be co-deposited with the organic compound represented by the aforementioned general formulas (1)-(5) is also preferably any substance selected from a group of a metal acetate salt, a metal halide and a metal alkoxide. Among these, in consideration of fluorescent intensity, such metal salt more preferably includes any metal element selected from a group of zinc, aluminum, silicon, gallium and zirconium having a high fluorescent intensity.

Also the layer formed by co-deposition of the organic compound represented by the aforementioned general formula (1)-(5) and the metal salt includes a metal complex represented by following general formulas (6)-(10). Therefore, in the present invention, in an electroluminescent device including at least an anode, a cathode and an electroluminescent layer provided between the anode and the cathode, the electroluminescent layer is having a characteristic of including a metal complex represented by following general formulas (6)-(10). The general formulas (6)-(10) will be explained in the following.

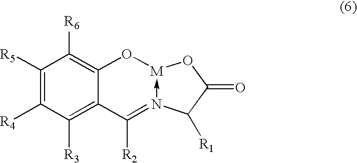

In the general formula (6), M represents a saturated or unsaturated metal ion; R1-R6 each represents a hydrogen element, a halogen element, a cyano group, an alkyl group (however limited to 1-10 carbon atoms), an alkoxyl group (however limited to 1-10 carbon atoms), a substituted or non-substituted aryl group (however limited to 1-20 carbon atoms), or a substituted or non-substituted heterocyclic residue group (however limited to 1-20 carbon atoms). And R3 and R4, R4 and R5 or R5 and R6 may be mutually bonded to form a benzene ring or poly-condensed rings (however limited to 1-20 carbon atoms). And R1 and R2 may be mutually bonded to form a pyridine ring.

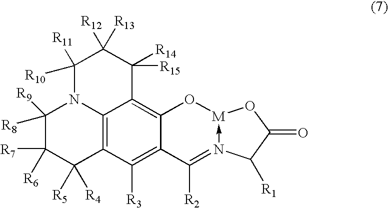

In the general formula (7), M represents a saturated or unsaturated metal ion. R1-R15 each represents a hydrogen element, a halogen element, a cyano group, an alkyl group (however limited to 1-10 carbon atoms), an alkoxyl group (however limited to 1-10 carbon atoms), a substituted or non-substituted aryl group (however limited to 1-20 carbon atoms), or a substituted or non-substituted heterocyclic residue group (however limited to 1-20 carbon atoms). And R1 and R2 may be mutually bonded to form a pyridine ring.

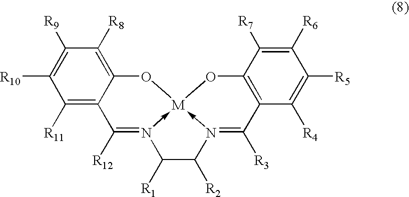

In the general formula (8), M represents a saturated or unsaturated metal ion. R1-R12 each represents a hydrogen element, a halogen element, a cyano group, an alkyl group (however limited to 1-10 carbon atoms), an alkoxyl group (however limited to 1-10 carbon atoms), a substituted or non-substituted aryl group (however limited to 1-20 carbon atoms), or a substituted or non-substituted heterocyclic residue group (however limited to 1-20 carbon atoms). And R1 and R2 may be mutually bonded to form a cycloalkane structure, a benzene ring or poly-condensed rings (however limited to 1 to 20 carbon atoms). And R4 and R5, R5 and R6, R6 and R7, R8 and R9, R9 and R10 or R10 and R11 may be mutually bonded to form a benzene ring or poly-condensed rings (however limited to 1-20 carbon atoms). And R2 and R3 or R1 and R12 may be mutually bonded to form a pyridine ring.

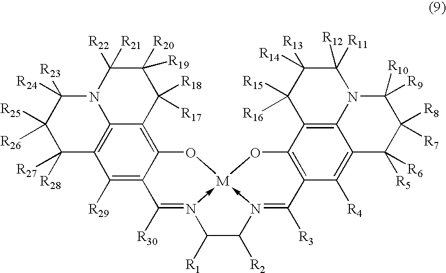

In the general formula (9), M represents a saturated or unsaturated metal ion. R1-R30 each represents a hydrogen element, a halogen element, a cyano group, an alkyl group (however limited to 1-10 carbon atoms), an alkoxyl group (however limited to 1-10 carbon atoms), a substituted or non-substituted aryl group (however limited to 1-20 carbon atoms), or a substituted or non-substituted heterocyclic residue group (however limited to 1-20 carbon atoms). And R1 and R2 may be mutually bonded to form a cycloalkane structure, a benzene ring or poly-condensed rings (however limited to 1 to 20 carbon atoms). And R2 and R3 or R1 and R30 may be mutually bonded to form a pyridine ring.

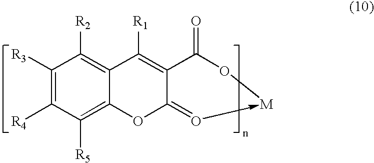

In the general formula (10), M represents a saturated or unsaturated metal ion. R1-R5 each represents a hydrogen element, a halogen element, a cyano group, an alkyl group (however limited to 1-10 carbon atoms), an alkoxyl group (however limited to 1-10 carbon atoms), a substituted or non-substituted aryl group (however limited to 1-20 carbon atoms), or a substituted or non-substituted heterocyclic residue group (however limited to 1-20 carbon atoms). And R4 may represent any of an amino group, a dialkylamino group, and an arylamino group. And R2 and R3, R3 and R4 or R4 and R5 may be mutually bonded to form a benzene ring or poly-condensed rings (however limited to 1 to 20 carbon atoms). And R3 and R4, or R4 and R5 may be mutually bonded to form a julolidine skeleton. And n represents an integer from 1 to 4.

In the metal complex having the structure represented by the aforementioned general formulas (6)-(10), in consideration of the fluorescent intensity, the aforementioned metal ion M is preferably any one of zinc, aluminum, silicon, gallium and zirconium.

The present invention also provides effective means on a process for manufacturing the aforementioned electroluminescent device. In the present invention, therefore, a method for manufacturing an electroluminescent device including at least an anode, a cathode and an electroluminescent layer provided between the anode and the cathode and including one or plural organic compound layers, is having a characteristic of a step of forming at least one of the aforementioned organic compound layers includes a step of co-depositing an organic compound including at least one each of a proton-donating functional group showing Bronsted acid and a functional group having a non-covalent electron pair, and a metal salt.

The proton-donating functional group is preferably any one selected from a group of a hydroxyl group, a carboxyl group and a mercapto group. Also the functional group having the non-covalent electron pair is preferably any one selected from a heterocyclic residue group, an azomethine group and a carbonyl group. It is also effective to utilize such proton-donating functional groups and such functional groups having the non-covalent electron pair respectively in combination.

On the other hand, the aforementioned metal salt is preferably any substance selected from a group of a metal acetate salt, a metal halide and a metal alkoxide.

In the manufacturing method for the electroluminescent device of the present invention, the organic compound having at least one each of the proton-donating functional group showing Bronsted acid and the functional group having non-covalent electron pair is preferably an organic compound represented by the foregoing general formulas (1)-(5). In the present invention, therefore, a method for manufacturing an electroluminescent device including at least an anode, a cathode and an electroluminescent layer provided between the anode and the cathode and including one or plural organic compound layers, is having a characteristic of a step for forming at least one of the organic compound layers comprises a step of co-depositing an organic compound represented by the foregoing general formulas (1)-(5) and a metal salt.

The metal salt to be co-deposited with the organic compound represented by the aforementioned general formulas (1)-(5) is also preferably any substance selected from a group of a metal acetate salt, a metal halide and a metal alkoxide. Among these, such metal salt more preferably includes any metal element selected from a group of zinc, aluminum, silicon, gallium and zirconium.

### BRIEF DESCRIPTION OF THE DRAWINGS

FIG. 1 is a view showing a specific element structure of an electroluminescent device of the present invention.

FIG. 2 is a view showing a mode of co-deposition.

FIG. 3 is a view showing a light emitting device in an Embodiment 3.

FIG. 4 is a view showing a specific example of an electric apparatus in an Embodiment 4.

### BEST MODE FOR CARRYING OUT THE INVENTION

An electroluminescent device in the present invention is basically an electroluminescent device comprising a layer of co-deposition of an ligand and metal salt mentioned in the foregoing or a layer containing a metal complex in an electroluminescent layer between a pair of electrodes (cathode and anode). In the field emission element, either one of the electrodes is required to be transparent in order to take out the light emission. It is therefore possible to adopt not only a conventional device configuration in which a transparent electrode is formed on a substrate and light is taken out through the substrate, but also a configuration in which the light is taken out from a side opposite to the substrate or a configuration in which the light is taken from both sides of electrodes.

In the following, materials to be employed in the present invention is explained with specific examples.

For forming a low-molecular metal complex of low sublimability or solubility as a film or in a film, the invention executes a co-deposition of an organic compound (ligand) and a metal salt serving as raw materials of the complex, thereby forming a thin film including a structure similar to such metal complex. The conditions of such organic compound (ligand) is required to include at least one each of a proton-donating functional group showing Bronsted acid and a functional group having non-covalent electron pair.

The proton-donating functional group is preferably a functional group capable of easily forming a covalent bond with a metal by releasing a proton. It can therefore be a hydroxyl group, a carboxyl group or a mercapto group. In particular, a phenolic hydroxyl group or a carboxyl group is useful.

Also the functional group having non-covalent electron pair is a functional group for coordination bonding to the metal, and is a heterocyclic residue group, an azomethine group or a carbonyl group and the like. It is representatively a pyridine ring, a Schiff base or an aromatic ketone as seen in a coumarine structure or a flavone structure.

On the other hand, the metal salt to be co-deposited with the aforementioned organic compound (ligand) is preferably a metal acetate salt, a metal halide, or a metal alkoxide. Specifically, such as zinc acetate (II), aluminum chloride (III), gallium chloride (III), zirconium chloride (IV) and silicon acetate (IV) are cited.

Also the organic compound (ligand) including at least one each of the proton-donating functional group showing Bronsted acid and the function group having non-covalent electron pair is preferably an organic compound represented by the foregoing general formulas (1)-(5).

These organic compounds are ligands showing strong fluorescent characteristics upon forming a chelate complex with a metal (particularly zinc, aluminum, silicon, gallium, zirconium and the like), but the complex, once formed, is difficult to dissolve in an organic solvent or to sublime, so that an application to the electroluminescent device by deposition of the complex is difficult. The reason of the difficulty of sublimation is presumably due to an increase the dipole moment by complex formation.

However, these organic compounds themselves generally have sublimability. Therefore, the electroluminescent device of the invention, manufactured by co-deposition of the organic compound represented by the foregoing general formulas (1)-(5) and the metal salt, allows to introduce, into the electroluminescent device, a substance having a structure similar to that of the metal complex of strong fluorescent property, which has not been applicable to the electroluminescent device.

Specific examples of the organic compound represented by the general formula (1)-(5) include following general formulas (11)-(19) and the like. In the following, the formulas (11)-(19) are explained.

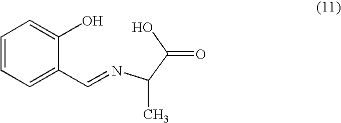

The structural formula (11) is an organic compound containing a hydroxyl group and a carboxyl group as the proton-donating substituent, and an azomethine structure as the substituent having non-covalent electron pair. The structural formula (11) corresponds to a compound of the foregoing general formula (1) in which R1 is a methyl group and R2-R6 are hydrogen elements.

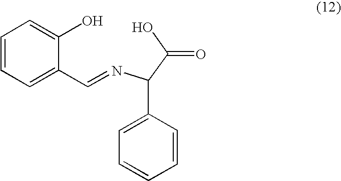

The structural formula (12) is an organic compound containing a hydroxyl group and a carboxyl group as the proton-donating substituent, and an azomethine structure as the substituent having non-covalent electron pair. The structural formula (12) corresponds to a compound of the foregoing general formula (1) in which R1 is a phenyl group and R2-R6 are hydrogen elements.

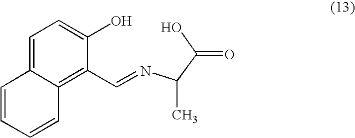

The structural formula (13) is an organic compound containing a hydroxyl group and a carboxyl group as the proton-donating substituent, and an azomethine structure as the substituent having non-covalent electron pair. The structural formula (13) corresponds to a compound of the foregoing general formula (1) in which R1 is a methyl group, R3 and R4 are mutually bonded to form a benzene ring, and R5 and R6 are hydrogen elements.

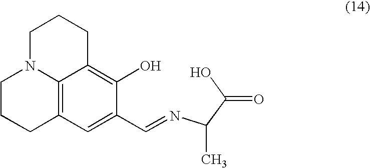

The structural formula (14) is an organic compound containing a hydroxyl group and a carboxyl group as the proton-donating substituent, and an azomethine structure as the substituent having non-covalent electron pair. The structural formula (14) corresponds to a compound of the foregoing general formula (2) in which R1 is a methyl group and R2-R15 are hydrogen elements.

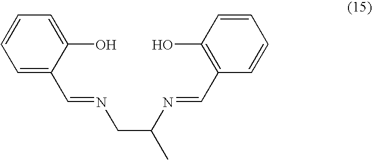

The structural formula (15) is an organic compound containing two hydroxyl groups as the proton-donating substituent, and two azomethine structures as the substituent having non-covalent electron pair. The structural formula (15) corresponds to a compound of the foregoing general formula (3) in which R2 is a methyl group and R1 and R3-R12 are hydrogen elements.

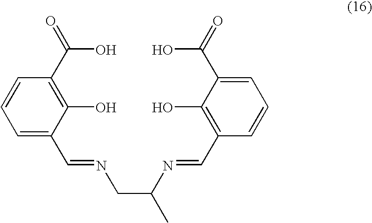

The structural formula (16) is an organic compound containing four hydroxyl groups as the proton-donating substituent, and two azomethine structures as the substituent having non-covalent electron pair. The structural formula (16) corresponds to a compound of the foregoing general formula (3) in which R2 is a methyl group, R7 and R8 are carboxyl groups, and R1, R3-R6, R9-R12 are hydrogen elements.

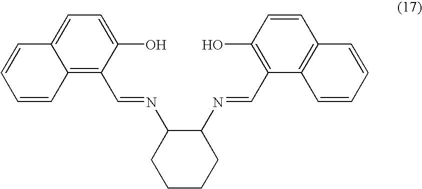

The structural formula (17) is an organic compound containing two hydroxyl groups as the proton-donating substituent, and two azomethine structures as the substituent having non-covalent electron pair. The structural formula (17) corresponds to a compound of the foregoing general formula (3) in which R1 and R2 are mutually bonded to form a cyclohexane structure, R4 and R5, and R10 and R11 are mutually bonded to form benzene rings, and R3, R6-R9 and R12 are hydrogen elements.

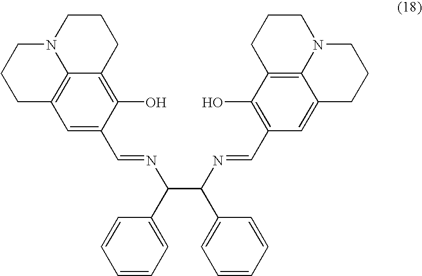

The structural formula (18) is an organic compound containing two hydroxyl groups as the proton-donating substituent, and two azomethine structures as the substituent having non-covalent electron pair. The structural formula (18) corresponds to a compound of the foregoing general formula (4) in which R1 and R2 are phenyl groups and R3-R30 are hydrogen elements.

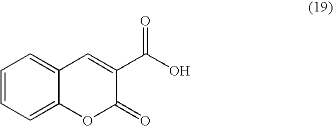

The structural formula (19) is an organic compound containing a carboxyl group as the proton-donating substituent, and a carbonyl group as the substituent having non-covalent electron pair. The structural formula (19) corresponds to a compound of the foregoing general formula (5) in which R1-R5 are hydrogen elements.

In the present invention, after such organic compound and the metal salt are co-deposited, heating under vacuum is preferably executed in order to achieve more efficient complex formation. Also the temperature of such heating is basically a reaction temperature at the synthesis of the original metal complex, and is preferably equal to or lower than a decomposition temperature of such metal complex. The temperature range is preferably 50 to 200° C.

Also, the co-deposited layer formed by co-deposition of the organic compound represented by the foregoing general formulas (1)-(5) and the metal salt is considered to contain the metal complex having a structure indicated by the foregoing general formulas (6)-(10). More specifically, by co-depositing any organic compound of the formulas (11)-(19) and zinc acetate, a layer containing a metal complex of a structure indicated respectively in following formulas (20)-(28) can be obtained. The metal complexes having such structures are difficult to sublime after the complex formation but show strong fluorescent property and are suitable for the invention.

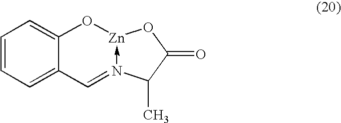

A structural formula (20) has a 3-coordination structure with respect to a metal center of divalent zinc. In this case, the coordination number 4 to zinc is not satisfied and sublimation is usually difficult. This structure corresponds to a case of the foregoing general formula (6) in which M is zinc, R1 is a methyl group, and R2-R6 are hydrogen elements.

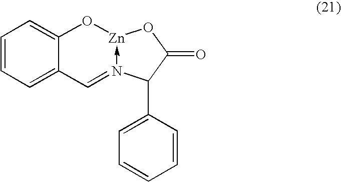

A structural formula (21) has a 3-coordination structure with respect to a metal center of divalent zinc. In this case, the coordination number 4 to zinc is not satisfied and sublimation is usually difficult. The structure (21) corresponds to a case of the foregoing general formula (6) in which M is zinc, R1 is a phenyl group, and R2-R6 are hydrogen elements.

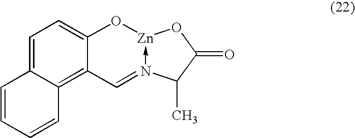

A structural formula (22) has a 3-coordination structure with respect to a metal center of divalent zinc. In this case, the coordination number 4 to zinc is not satisfied and sublimation is usually difficult. The structure (22) corresponds to a case of the foregoing general formula (6) in which M is zinc, R1 is a methyl group, R3 and R4 are mutually bonded to form a benzene ring, and R5 and R6 are hydrogen elements.

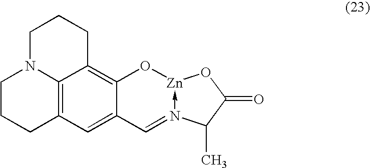

A structural formula (23) has a 3-coordination structure with respect to a metal center of divalent zinc. In this case, the coordination number 4 to zinc is not satisfied and sublimation is usually difficult. The structure (23) corresponds to a case of the foregoing general formula (7) in which M is zinc, R1 is a methyl group, and R2-R15 are hydrogen elements.

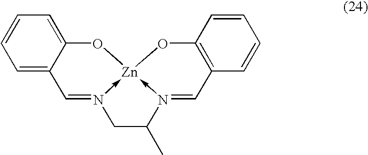

A structural formula (24) is a 4-coordination complex with respect to a metal center of divalent zinc, thus satisfying the coordination number, but sublimation is difficult because of a large dipole moment. The structural formula (24) corresponds to a case of the foregoing general formula (8) in which M is zinc, R2 is a methyl group, and R1, R3-R12 are hydrogen elements.

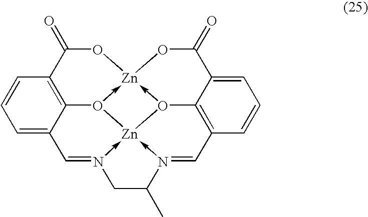

A structural formula (25) is a complex with 4-coordination to each of two metal centers of divalent zinc, thus satisfying the coordination number, but sublimation is difficult because of a large dipole moment. The structural formula (25) corresponds to a case of the foregoing general formula (8) in which M is zinc, R2 is a methyl group, R7 and R8 are carboxyl groups and R1, R3-R6, R9-R12 are hydrogen elements.

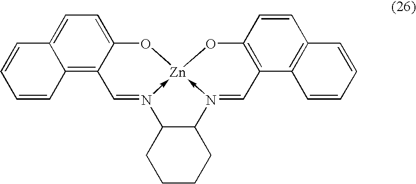

A structural formula (26) is a complex with 4-coordination to a metal center of divalent zinc, thus satisfying the coordination number, but sublimation is difficult because of a large dipole moment. The structural formula (26) corresponds to a case of the foregoing general formula (8) in which M is zinc, R1 and R2 are mutually bonded to form a cyclohexane structure, R4 and R5, and R10 and R11 each are mutually bonded to form a benzene ring, and R3, R6-R9 and R12 are hydrogen elements.

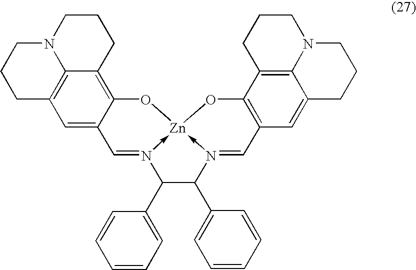

A structural formula (27) is a complex with 4-coordination to a metal center of divalent zinc, thus satisfying the coordination number, but sublimation is difficult because of a large dipole moment. The structural formula (27) corresponds to a case of the foregoing general formula (9) in which M is zinc, R1 and R2 are phenyl groups, and R3-R30 are hydrogen elements.

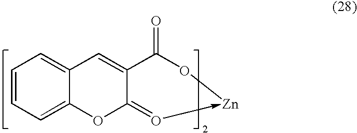

A structural formula (28) is a complex with 4-coordination to a metal center of divalent zinc, thus satisfying the coordination number. However, the bond between the ligand and the metal center is weak, having a decomposition temperature of about 200° C. Therefore, in the state of metal complex, decomposition takes place before sublimation. The structural formula (28) corresponds to a case of the foregoing general formula (10) in which M is zinc, and R1-R5 are hydrogen elements.

In the metal complex of the structure shown in the foregoing structural formulas (20)-(28), the metal center is zinc, but the present invention is not limited to such case and any metal capable of complex formation can be employed. From the standpoint of fluorescent intensity, there can be preferably employed aluminum, silicon, gallium or zirconium and the like in addition to zinc. It is also preferable to match an optimum coordination number of the metal with the coordination number of the ligand. For example, in the structural formula (28), in the case of employing aluminum (coordination number 6) as the metal center, the number of the ligands is preferably selected as 3. However, the present invention is not limited to such case.

In the following, the electroluminescent device of the present invention is explained in details.

(Embodiment Mode 1)

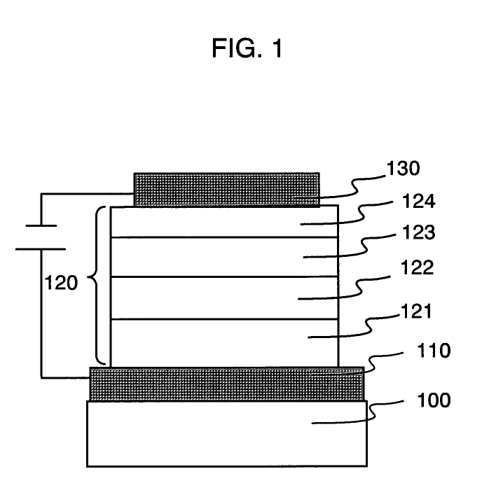

In the present embodiment mode 1, a configuration of the electroluminescent device is explained with reference to FIG. 1, in a case of co-depositing and heating the aforementioned organic compound (ligand) and the metal salt to obtain a layer as a light emission layer.

In FIG. 1, a first electrode 110 is formed on a substrate 100, then a light emitting layer 120 is formed on the first electrode 110, and a second electrode 130 is formed thereon.

A material to be used in the substrate 100 can be a material employed in the conventional electroluminescent device, such as glass, quartz or transparent plastics.

In the present embodiment mode 1, the first electrode 110 functions as an anode, and the second electrode 130 functions as a cathode.

The first electrode 110 is formed by an anode material, and the anode material that can be employed is preferably a metal, an alloy, an electrically conductive compound, or a mixture thereof, with a large work function (work function of 4.0 eV or larger). Specific examples of the anode material include ITO (indium tin oxide) and IZO (indium zinc oxide) formed by mixing indium oxide with zinc oxide (ZnO) of 2-20 [%], and also gold (Au), platinum (Pt), nickel (Ni), tungsten (W), chromium (Cr), molybdenum (Mo), iron (Fe), cobalt (Co), copper (Cu), palladium (Pd), and a nitride of a metal material (TiN) and the like.

On the other hand, a cathode material to be employed for forming the second electrode 130 is preferably a metal, an alloy, an electrically conductive compound or a mixture thereof with a small work function (work function of 3.8 eV or smaller). The cathode material can be formed with an element belonging to group 1 or 2 of the periodic table, namely an alkali metal such as Li or Cs, or alkali earth metal such as Mg, Ca, or Sr, an alloy containing the same (Mg:Ag, Al:Li) or a compound (LiF, CsF, CaF₂), or with a transition metal containing a rare earth metal, or by lamination with a metal (including alloy) such as Al, Ag or ITO.

The aforementioned anode material and cathode material are formed into thin films by deposition, sputtering and the like. to respectively form the first electrode 110 and the second electrode 130. A film thickness is preferably 10-500 nm.

The electroluminescent layer 120 is formed by laminating plural layers, and, in the present embodiment mode 1, is formed by laminating a hole injection layer 121, a hole transport layer 122, a light emitting layer 123 and an electron injection layer 124. For the layers laminated in the electroluminescent device, laminating method is not restricted except for the layer formed by co-deposition of the organic compound and the metal salt. Any method such as a vacuum deposition method, a spin coating method, an ink jet method or a dip coating method may be selected as long as lamination is possible.

In such configuration, as a hole injecting material to be used for forming the hole injection layer 121, in the case of an organic compound, a porphyrin compound is effective and there can be employed phthalocyanine (hereinafter represented as H₂-Pc) or CuPc and the like. Also there can be employed a conductive polymer compound subjected to chemical doping, such as polyethylene dioxythiophene (hereinafter represented as PEDOT) doped with polystyrene sulfonic acid (hereinafter represented as PSS), polyaniline, or polyvinylcarbazole (hereinafter represented as PVK) and the like.

Also a hole transporting material to be used for forming the hole transport layer 122 is preferably an aromatic amine compound (namely containing a benzene ring-nitrogen bond). Widely used materials include a star-burst aromatic amine compound such as N,N′-bis(3-methylphenyl)-N,N′-diphenyl-[1,1′-biphenyl]-4,4′-diamine (hereinafter represented as TPD), a derivative thereof 4,4′-bis[N-(1-naphthyl)-N-phenyl-amino]-biphenyl (hereinafter represented as NPB), 4,4′,4″-tris(N,N-diphenyl-amino)-triphenylamine (hereinafter represented as TDATA), and 4,4′,4″-tris[N-(3-methylphenyl)-N-phenyl-amino]-triphenylamine (hereinafter represented as MTDATA) and the like.

Also the light emitting layer 123 is formed by co-depositing the aforementioned organic compound (for example an organic compound represented by the general formula (1), general formula (2), general formula (3), general formula (4), or general formula (5) and the like) and a metal salt (for example a metal acetate salt, a metal halide or a metal alkoxide and the like). In this operation, a molar ratio of the organic compound and the metal salt at the deposition is preferably approximately the same as the molar ratio of the ligand and the metal center of the original metal complex.

The layer formed by co-deposition of the organic compound and the metal salt is preferably heated in vacuum, after the co-evaporation. The temperature in this case is preferably close to a temperature at the synthesis of the original metal complex by a reaction of the organic compound and the metal salt, and is preferably lower than a decomposition temperature of such complex. A standard temperature is 50-200° C.

Also a material forming the electron injection layer 124 is preferably an insulating material which is used with a film thickness of up to about 3 nm, not causing to insulate. It can for example be Ca₂F or Ba₂F.

Also, though not illustrated in FIG. 1, an electron transport layer may be provided between the light emitting layer 123 and the electron injection layer 124. An electron transporting material to be used for forming the electron transport layer can advantageously be, in addition to Alq mentioned in the foregoing, a metal complex having a quinoline skeleton or a benzoquinoline skeleton such as tris(5-methyl-8-qinolilato)aluminum (Almq), bis(10-hydroxybenzo[h]-quinolilato)beryllium (BeBq), or bis(2-methyl-8-quinolilato)-4-phenylphenolato-aluminum (BAlq). Also there are metal complexes having an oxazole or thiazole ligand such as bis[2-(2-hydroxyphenyl)-benzooxazolato]zinc (Zn(BOX)), or bis[2-(2-hydroxyphenyl)-benzothiazolato]zinc (Zn(BTZ)). In addition to the metal complexes, it is also possible to use 2-(4-biphenylyl)-5-(4-tert-butylphenyl)-1,3,4-oxadiazole (PBD), 1,3-bis[5-(p-tert-butylphenyl)-1,3,4-oxadiazol-2-yl]benzene (OXD-7), 3-(4-tert-butylphenyl)-4-phenyl-5-(4-biphenylyl)-1,2,4-triazole (TAZ), 3-(4-tert-butylphenyl)-4-(4-ethylphenyl)-5-(4-biphenylyl)-1,2,4-triazole (p-EtTAZ), bathophenanthroline (BPhen), or bathocuproine (BCP) and the like as the electron transport material.

The thus obtained electroluminescent device of the present embodiment mode 1 is an electroluminescent device including, as a light emitting layer 123, a layer formed by co-depositing an organic compound (ligand) and a metal salt, which are raw materials of a complex that is poor in sublimability or solubility but is superior in thermal stability or fluorescent intensity, followed by superheating. Therefore, the electroluminescent device is the light emitting element having a color of light emitting obtained from such layer.

In the embodiment mode 1, the co-deposition layer of the invention is employed in the light emitting layer 123, but the present invention is not limited to such case. The aforementioned co-deposited layer or the metal complex having the structure indicated by the foregoing general formulas (6)-(10) have characteristics suitable for a layer other than the light emitting layer (for example, a hole injection layer, a hole transport layer, a hole blocking layer, an electron transport layer, an electron injection layer, or a buffer layer), it may be used in such layers. The characteristics in this case indicate a HOMO level, a LUMO level, an excitation spectrum, a light emitting spectrum, an absorption spectrum and the like.

In the layers other than the layer obtained by co-depositing and heating the organic compound (ligand) and the metal salt, or in the layers other than the layer utilizing the metal complex of the structure indicated by the general formulas (6)-(10), there can be employed a known material, which can be a low molecular material or a high molecular material. The material constituting the electroluminescent layer includes not only a composition constituted solely of an organic compound but also a composition containing an inorganic compound in a part.

In the present embodiment mode 1, a layer in the electroluminescent layer is formed by co-deposition and heating one type of ligand and one type of metal salt, but the present invention is not limited to such case. For example, in case of forming a layer including metal complexes of two types with different metal centers but with a same ligand, a film can be formed by co-depositing two types of metal salts and one type of ligand.

Also in the present embodiment mode 1, a layer in the electroluminescent layer is formed by co-depositing and heating one type of ligand and one type of metal salt only, but the present invention is not limited to such case. It is possible, for example, to further co-deposit a substance serving as a dopant (for example a fluorescent dye such as perylene or rubrene). In such case, the heating of the substrate is preferably executed at a temperature not causing a damage in the dopant.

Hereinbefore, in the present embodiment mode 1, there has been explained a case of so-called forward lamination type in which the first electrode 110 formed on the substrate functions as an anode utilizing an anode material and the second electrode 130 functions as a cathode utilizing a cathode material, but the present invention is not limited to such case. For example by forming the first electrode 110 with a cathode material and the second electrode 130 with an anode material, the first electrode 110 can be made to function as the cathode while the second electrode 130 can be made to function as the anode. In this case, however, the laminate structure of the electroluminescent device is inverted and becomes a device configuration generally called reverse lamination type.

In the electroluminescent device of the present invention, light generated by recombination of carriers in the electroluminescent layer is emitted to the exterior, through either or both of the first electrode 110 and the second electrode 130. Thus, in the case the light is emitted through the first electrode 110, the first electrode 110 is formed by a translucent material, and, in the case the light is emitted through the second electrode 130, the second electrode 130 is formed by a translucent material.

(Embodiment Mode 2)

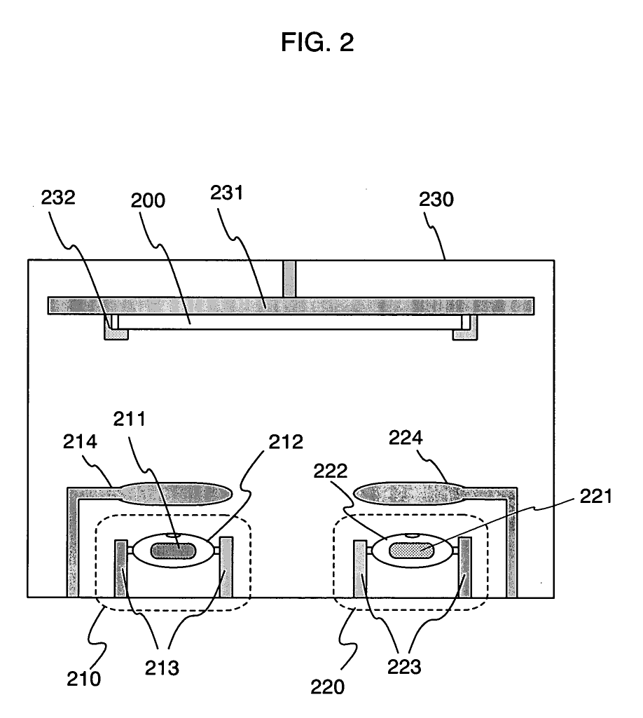

The present embodiment mode 2 explains a specific form of the aforementioned co-deposition method with reference to FIG. 2. FIG. 2 is a cross-sectional view of a deposition device. A deposition source can be of a type utilizing a cell or a type utilizing a conductive heating element, and FIG. 2 shows a case of utilizing a conductive heating element.

At first, a container a212 filled with the aforementioned organic compound 211 is fixed to an electrode a213 positioned in a lower part of an evaporation chamber 230. Similarly, a container b222 filled with the aforementioned metal salt 221 is fixed to an electrode b223. A substrate 200, formed a film of a first electrode of the electroluminescent device, is fixed on a rotary disk 231 provided in an upper part of the evaporation chamber 230, by a substrate receiver 232 in such a manner that the first electrode is positioned downwards.

Then, voltages are applied to the electrode a213 and the electrode b223 to heat the containers a212 and b222, thereby respectively heating and subliming the organic compound 211 and the metal salt 221 contained therein. Subsequently, shutters a214 and b224 are simultaneously opened whereby the organic compound 211 and the metal salt 221 are co-evaporated on the substrate 200. At this time, by more uniform deposition can be attained by rotating the rotary disk 231 in a horizontal direction with respect to the organic compound deposition source 210 and the metal salt deposition source 220.

(Embodiments)

In the following, examples of manufacturing processes and embodiments of the electroluminescent layer to be employed in the present invention are explained, but the present invention is not limited to these examples.

[Embodiment 1]

This embodiment specifically shows a synthesizing method of an organic compound to be employed in the co-deposition.

20 ml of methanol solution of 1.72 g of 1-hydroxy-2-naphtaldehyde and 50 ml of methanol solution of 0.57 g of 1,2-cyclohexanediamine are mixed (with a molar ratio of 2:1) and stirred for 1-2 hours, whereby yellow crystals are precipitated. The precipitate is obtained by filtration under a reduced pressure, and dried in a vacuum oven to obtain 1,2-bis(2-hydroxy-1-naphthylidene)-cyclohexanediamine (hereinafter indicated as na2-cHex) (indicated in a structural formula (17)). It has a crystallization temperature of 120° C., a melting point of 205° C. and a decomposition temperature of 305° C. 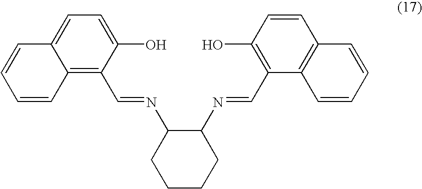
[Embodiment 2]

This embodiment specifically shows manufacturing processes of an electroluminescent device having a structure shown in the embodiment mode 1, with reference to FIG. 1.

At first, on a glass substrate 100, ITO which is a transparent conductive film is formed by sputtering, as a first electrode 110, with a thickness of 110 nm.

Then an electroluminescent layer 120 is formed on the first electrode 110. In the present embodiment, the electroluminescent layer 120 has a structure laminated in an order of a hole injection layer 121, a hole transport layer 122, a light emitting layer 123 and an electron injection layer 124. These layers are formed in succession, in a state where the substrate 100 bearing the first electrode 110 is fixed on a substrate holder of a commercially available vacuum deposition device with the first electrode 110 downwards, by vacuum deposition of materials from below. In this case, the materials are filled in a boat of tungsten and the like. or a crucible of alumina and the like and are evaporated by heating such a boat or a crucible.

At first, on the first electrode 110, a hole injection layer 121 is formed by vacuum deposition. In this embodiment, Cu-Pc is formed with a film thickness of 20 nm.

Then, on the hole injection layer 121, a hole transport layer 122 is formed in a similar method. In this embodiment, TPD is formed with a film thickness of 30 nm.

Then, on the hole transport layer 122, na2-cHex constituting a ligand and zinc acetate constituting a metal salt are co-deposited in a similar method. In this case, a film is formed with a molar ratio of na2-cHex and zinc acetate of about 1:1 thereby forming a light emitting layer 123. Thereafter heating is executed at 70° C.

Then, on the light emitting layer 123, an electron injection layer 124 is formed in a similar method. In this embodiment, calcium fluoride (hereinafter represented as CaF) is formed with a film thickness of 2 nm.

Finally, on the electroluminescent layer 124, a second electrode 130 functioning as a cathode is formed and laminated similarly by vacuum deposition. In this embodiment, aluminum (hereinafter represented as Al) is formed with a film thickness of 100 nm.

In this manner, an electroluminescent device utilizing, as a light emitting layer, a film formed by co-depositing and heating an organic compound and a metal salt containing a metal center is obtained.

[Embodiment 3]

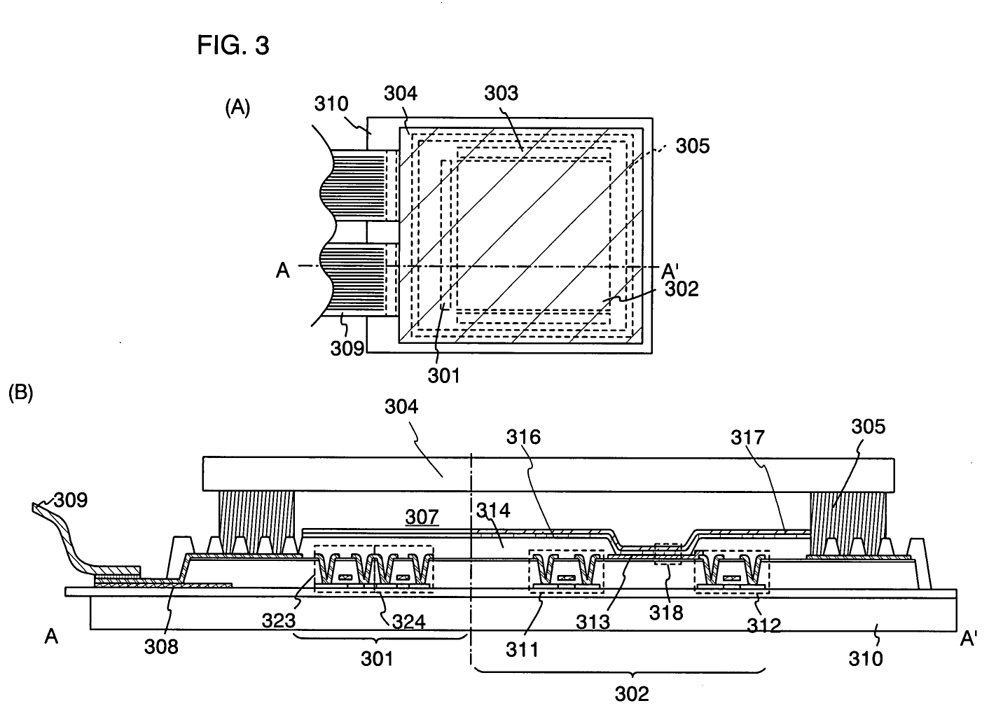

This embodiment explains a light emitting device having an electroluminescent device of the present invention in a pixel portion, with reference to FIG. 3. FIG. 3(A) is a top view showing the light emitting device, and FIG. 3(B) is a cross-sectional view along A-A′ in FIG. 3(A). 301 represented by a dotted line is a driver circuit portion (source side driver circuit), 302 is a pixel portion, and 303 is a driver circuit portion (gate side driver circuit). Also, 304 is a sealing substrate, 305 is a sealant, and inside surrounded by the sealant 305 is a space.

In the following, a cross-sectional structure is explained with reference to FIG. 3(B). On a substrate 310, a driver circuit portion and a pixel portion are formed, a source driver circuit 301 as the driver circuit portion and a pixel portion 302 are illustrated here.

In the source side driver circuit 301, a CMOS circuit is formed by combining an n-channel type TFT 323 and a p-channel type TFT 324.

The TFT constituting the driver circuit may be formed by a CMOS circuit, a PMOS circuit or an NMOS circuit already known. In the present embodiment mode, a driver-integral type in which the driver circuit is formed on the substrate is shown, but such configuration is not necessarily essential and it may be formed not on the substrate but formed in the outside.

The pixel portion 302 is formed by plural pixels including a switch TFT 311, a current controlling TFT 312 and a first electrode 313 connected electrically to a drain thereof. An insulator 314 is formed covering an end portion of the first electrode 313. In this case, it is formed by using a positive-type photosensitive acrylic resin film.

Also for obtaining a satisfactory coverage, a curved plane is formed with a curvature in an upper end portion or a lower end portion of the insulator 314. For example, in case a positive-type photosensitive acrylic resin as the material of the insulator 314, it is preferred that a curved plane having a radius of curvature (0.2-3 μm) is formed only in the upper end portion of the insulator 314. Also as the insulator 314, it is also possible to use a negative-type which becomes insoluble to an etchant by a photosensitive light, or a positive-type which becomes soluble in an etchant by light.

On the first electrode 313, an electroluminescent layer 316 and a second electrode 317 are respectively formed. A material to be employed in the first electrode 313 functioning as the anode is desirably a material of a large work function. For example, there can be employed a single-layered film such as an ITO (indium tin oxide) film, an indium zinc oxide (IZO) film, a titanium nitride film, a chromium film, a tungsten film, a Zn film or a Pt film, a laminated film principally formed by titanium nitride and aluminum, or a three-layered film of a titanium nitride film, and a film principally constituted of aluminum and a titanium nitride film. A laminate structure provides a low resistance in the wiring, a satisfactory ohmic contact and also allows to function as an anode.

The electroluminescent layer 316 is formed by a deposition method utilizing a deposition mask, or an ink jet method and the like, and a co-deposition film disclosed in the present invention is used as a part of the electroluminescent layer 316. More specifically, an electroluminescent layer indicated in the embodiment 2 may be employed.

Also a material to be used in the second electrode (cathode) 317 formed on the electroluminescent layer 316 can be a material of a small work function (Al, Ag, Li, Ca or an alloy thereof such as MgAg, MgIn, AlLi, CaF₂ or CaN). In case the light generated in the electroluminescent layer 316 is transmitted into the second electrode 317, the second electrode (cathode) 317 is preferably formed by a lamination of a metal film of a reduced film thickness and a transparent conductive film (ITO (indium oxide-tin oxide alloy), an indium oxide-zinc oxide alloy (In₂O₃—ZnO), zinc oxide (ZnO) and the like).

Then, by adhering a sealing substrate 304 with the element substrate 310 with a sealant 305, there is obtained a structure provided with the electroluminescent device 318 in a space 307 surrounded by the element substrate 310, the sealing substrate 304 and the sealant 305. In addition to a case where an inert gas (nitrogen or argon) is filled in the space 307, there is included a configuration which is filled with the sealant 305.

An epoxy resin is preferably employed as the sealant 305. Such materials are preferably not to transmit to moisture and oxygen as far as possible. A material to be employed in the sealing substrate 304 can be, in addition to a glass substrate, a quartz substrate or a stainless steel can, a plastic substrate constituted of FRP (fiberglass-reinforced plastics), PVF (polyvinyl fluoride), Mylar, polyester or acrylic resin and the like. Also the sealing substrate 304 may not be employed, in case a layer of the sealant 305 not to transmit to moisture or oxygen is formed on the pixel portion 302 and provides an effect of preventing deterioration of the electroluminescent device comparable to that by the sealing substrate.

308 is a wiring for transmitting signals to be entered into the source side driver circuit 301 and the gate side driver circuit 303, and receives a video signal, a clock signal, a start signal, a reset signal and the like from an FPC (flexible printed circuit) 309 serving as an external input terminal. Though the only FPC is illustrated, a printed wiring board (PWB) may be mounted on the FPC. The light emitting device in the present specification includes not only the light emitting device itself but also a state where an FPC or a PWB is mounted thereto.

The light emitting device including the electroluminescent device of the present invention can be obtained in the manner explained above.

[Embodiment 4]

This embodiment explains various electrical apparatuses completed with the light emitting device including the electroluminescent device of the present invention.

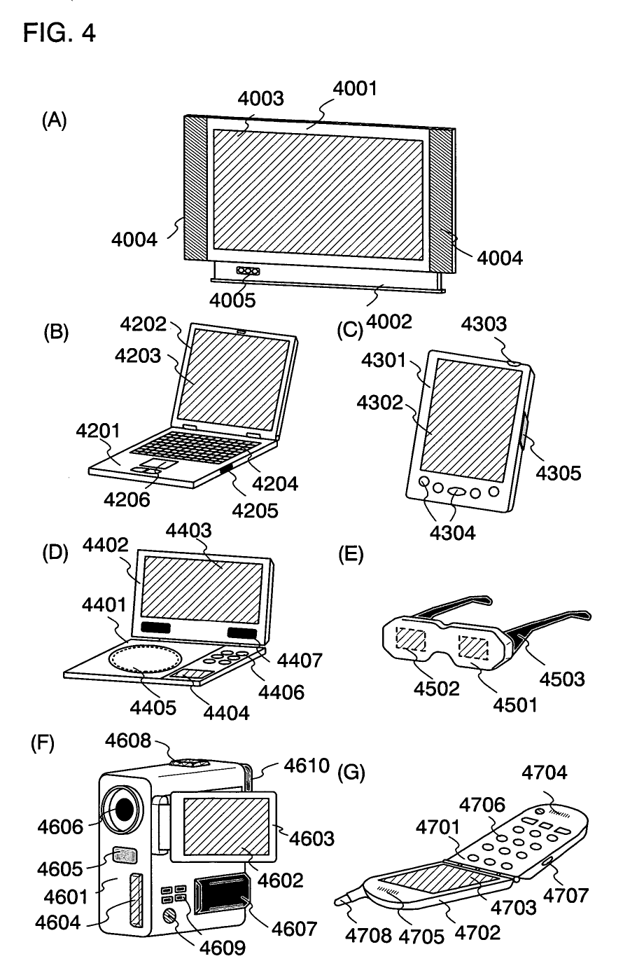

Electronic devices, using the light emitting element having the electroluminescent device of the present invention, include a video camera, a digital camera, a goggle-type display (head mounted display), a navigation system, a sound reproducing device (a car audio equipment, an audio component stereo and the like), a laptop personal computer, a game machine, a portable information terminal (a mobile computer, a cellular phone, a portable game machine, an electronic book and the like), an image reproducing device including a recording medium (more specifically an apparatus which can reproduce a recording medium such as a digital versatile disk (DVD) and so forth, and includes a display for displaying the reproduced image) or the like. Specific examples of these electronic devices are shown in FIG. 4.

FIG. 4(A) shows a display device, including a housing 4001, a support base 4002, a display portion 4003, a speaker portion 4004, a video input terminal 4005 and the like. It is manufactured by employing the light emitting device, including the electroluminescent device of the present invention, in the display portion 4003. The display device includes all the information display apparatus, such as for personal computer, for receiving TV broadcast or for advertisement display.

FIG. 4(B) shows a laptop personal computer, including a main body 4201, a housing 4202, a display portion 4203, a keyboard 4204, an external connection port 4205, a pointing mouse 4206 and the like. It is manufactured by employing the light emitting device, including the electroluminescent device of the invention, in the display portion 4203.

FIG. 4(C) shows a mobile computer, including a main body 4301, a display portion 4302, a switch 4303, an operation key 4304, an infrared port 4305 and the like. It is prepared by employing the light emitting device, including the electroluminescent device of the invention, in the display portion 4302.

FIG. 4(D) shows a portable image reproducing device provided with a recording medium (more specifically a DVD reproducing apparatus), including a main body 4401, a housing 4402, a display portion A 4403, a display portion B 4404, a recording medium (such as DVD) read-in portion 4405, operation keys 4406, a speaker portion 4407 and the like. The display portion A 4403 principally displays image data, while the display portion B 4404 principally displays text data, and it is prepared by employing the light emitting device, including the electroluminescent device of the invention, in the display portion A 4403 and B 4404. The image reproducing device provided with the recording medium includes a home-use game machine.

FIG. 4(E) shows a goggle-type display (head mount display), including a main body 4501, a display portion 4502, and an arm portion 4503. It is prepared by employing the light emitting device, including the electroluminescent device of the invention, in the display portion 4502.

FIG. 4(F) shows a video camera, including a main body 4601, a display portion 4602, a housing 4603, an external connection port 4604, a remote control receiving portion 4605, an image receiving portion 4606, a battery 4607, an audio input portion 4608, operation keys 4609, an eyepiece 4610 and the like. It is prepared by employing the light emitting device, including the electroluminescent device of the invention, in the display portion 4602.

FIG. 4(G) shows a mobile telephone, including a main body 4701, a housing 4702, a display portion 4703, an audio input portion 4704, an audio output portion 4705, operation keys 4706, an external connection port 4707, an antenna 4708 and the like. It is prepared by employing the light emitting device, including the electroluminescent device of the invention, in the display portion 4703. The display unit 4703 can suppress the electric power consumption of the mobile telephone by displaying white characters on a black background.

As explained in the foregoing, the light emitting device including the electroluminescent device of the present invention has an extremely wide field of application, and it can be applied to the electronic devices of various field.

### INDUSTRIAL APPLICABILITY

The present invention may be applied, even for a material for which deposition or solution coating is difficult in a complex state, to form a thin film containing such complex. It is therefore possible to provide an electroluminescent device such complexes.

1. An electroluminescent device comprising:
an anode;
a cathode; and
an electroluminescent layer between the anode and the cathode,
wherein the electroluminescent layer includes a layer formed by co-deposition of an organic compound and a metal salt, and the organic compound includes of a proton-donating functional group showing Bronsted acid and a functional group having a non-covalent electron pair.

2. The electroluminescent device according to claim 1, wherein the proton-donating functional group is one of a hydroxyl group, a carboxyl group and a mercapto group.

3. The electroluminescent device according to claim 1, wherein the functional group having the non-covalent electron pair is one of a heterocyclic residue group, an azomethine group and a carbonyl group.

4. The electroluminescent device according to claim 1, wherein the proton-donating functional group is one of a hydroxyl group, a carboxyl group and a mercapto group, and the functional group having the non-covalent electron pair is one of a heterocyclic residue group, an azomethine group and a carbonyl group.

5. The electroluminescent device according to claim 1, wherein the metal salt is one of a metal acetate salt, a metal halide and a metal alkoxide.

6. An electroluminescent device comprising:
an anode;
a cathode; and
an electroluminescent layer between the anode and the cathode,
wherein the electroluminescent layer includes a layer formed by co-deposition of an organic compound and a metal salt, and the organic compound is a compound represented by a following general formula (1): 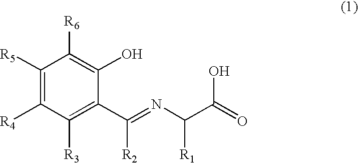
wherein R₁-R₆ each represents one of a hydrogen element, a halogen element, a cyano group, an alkyl group (1-10 carbon atoms), an alkoxyl group (1-10 carbon atoms), a substituted or non-substituted aryl group (1-20 carbon atoms), and a substituted or non-substituted heterocyclic residue group (1-20 carbon atoms), including cases of R₃ and R4, R4 and R₅ or R₅ and R6 being mutually bonded to form a benzene ring or poly-condensed rings (1-20 carbon atoms) and R₁ and R₂ being mutually bonded to form a pyridine ring.

7. An electroluminescent device comprising;
an anode;
a cathode; and
an electroluminescent layer between the anode and the cathode,
wherein the electroluminescent layer includes a layer formed by co-deposition of an organic compound and a metal salt, and the organic compound is a compound represented by a following general formula (2): 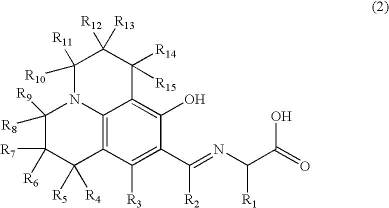
wherein R₁-R₁₅ each represents one of a hydrogen element, a halogen element, a cyano group, an alkyl group (1-10 carbon atoms), an alkoxyl group (1-10 carbon atoms), a substituted or non-substituted aryl group (1-20 carbon atoms), and a substituted or non-substituted heterocyclic residue group (1-20 carbon atoms), including a case of R₁ and R₂ being mutually bonded to form a pyridine ring.

8. An electroluminescent device comprising:
an anode;
a cathode; and
an electroluminescent layer between the anode and the cathode,
wherein the electroluminescent layer includes a layer formed by co-deposition of an organic compound and a metal salt, and the organic compound is a compound represented by a following general formula (3): 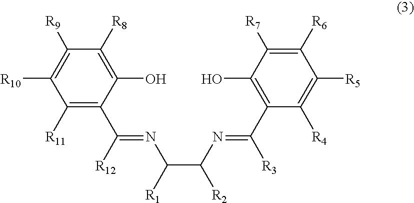
wherein R₁-R₁₂ each represents one of a hydrogen element, a halogen element, a cyano group, an alkyl group (1-10 carbon atoms), an alkoxyl group (1-10 carbon atoms), a substituted or non-substituted aryl group (1-20 carbon atoms), and a substituted or non-substituted heterocyclic residue group (1-20 carbon atoms), including cases of R₁ and R₂ being mutually bonded to form a cycloalkane structure, a benzene ring or poly-condensed rings (1 to 20 carbon atoms), R₄ and R₅, R₅ and R₆, R₆ and R₇, R₈ and R₉, R₉ and R₁₀ or R₁₀ and R₁₁ being mutually bonded to form a benzene ring or poly-condensed rings (1-20 carbon atoms), and R₂ and R₃ or R₁ and R₁₂ being mutually bonded to form a pyridine ring.

9. An electroluminescent device comprising:
an anode;
a cathode; and
an electroluminescent layer between the anode and the cathode,
wherein the electroluminescent layer includes a layer formed by co-deposition of an organic compound and a metal salt, and the organic compound is a compound represented by a following general formula (4): 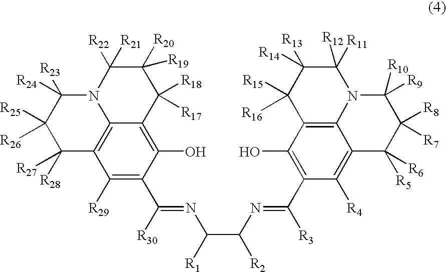
wherein R₁-R₃₀ each represents one of a hydrogen element, a halogen element, a cyano group, an alkyl group (1-10 carbon atoms), an alkoxyl group (1-10 carbon atoms), a substituted or non-substituted aryl group (1-20 carbon atoms), or a substituted or non-substituted heterocyclic residue group (1-20 carbon atoms), including cases of R₁ and R₂ being mutually bonded to form a cycloalkane structure, a benzene ring or poly-condensed rings (1 to 20 carbon atoms) and R₂ and R₃ or Rand R₃₀ being mutually bonded to form a pyridine ring.

10. An electroluminescent device including:
an anode;
a cathode; and
an electroluminescent layer between the anode and the cathode,
wherein the electroluminescent layer includes a layer formed by co-deposition of an organic compound and a metal salt, and the organic compound is a compound represented by a following general formula (5): 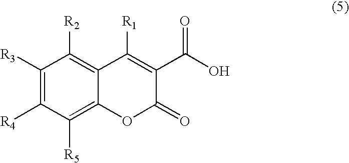
wherein R₁-R₅ each represents one of a hydrogen element, a halogen element, a cyano group, an alkyl group (1-10 carbon atoms), an alkoxyl group (1-10 carbon atoms), a substituted or non-substituted aryl group (1-20 carbon atoms), and a substituted or non-substituted heterocyclic residue group (1-20 carbon atoms), including cases of R₄ representing one of an amino group, a dialkylamino group, and an arylamino group, R₂ and R₃, R₃ and R₄ or R₄ and R₅ being mutually bonded to form a benzene ring or poly-condensed rings (1 to 20 carbon atoms), and R₃ and R₄, or R₄ and R₅ being mutually bonded to form a julolidine skeleton.

11. The electroluminescent device according to any one of claims 6 to 10,
wherein the metal salt is one of a metal acetate salt, a metal halide and a metal alkoxide.

12. The electroluminescent device according to any one of claims 6 to 10,
wherein the metal salt comprises one of zinc, aluminum, silicon, gallium and zirconium.

13. An electroluminescent device comprising:
an anode;
a cathode; and
an electroluminescent layer between the anode and the cathode,
wherein the electroluminescent layer is formed by co-deposition of an organic compound and a metal salt, and includes a metal complex having a structure represented by a following general formula (6): 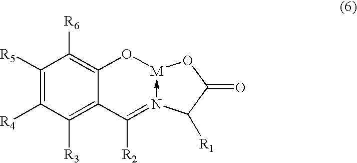
wherein M represents a saturated or unsaturated metal ion, R₁-R₆ each represents one of a hydrogen element, a halogen element, a cyano group, an alkyl group (1-10 carbon atoms), an alkoxyl group (1-10 carbon atoms), a substituted or non-substituted aryl group (1-20 carbon atoms), and a substituted or non-substituted heterocyclic residue group (1-20 carbon atoms), including cases of R₃ and R₄, R₄ and R₅ or R₅ and R₆ being mutually bonded to form a benzene ring or poly-condensed rings (1-20 carbon atoms) and R₁ and R₂ being mutually bonded to form a pyridine ring.

14. An electroluminescent device comprising:
an anode;
a cathode; and
an electroluminescent layer between the anode and the cathode,
wherein the electroluminescent layer is formed by co-deposition of an organic compound and a metal salt, and includes a metal complex having a structure represented by a following general formula (7): 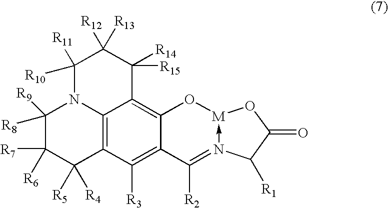
wherein M represents a saturated or unsaturated metal ion and R₁-R₁₅ each represents one of a hydrogen element, a halogen element, a cyano group, an alkyl group (1-10 carbon atoms), an alkoxyl group (1-10 carbon atoms), a substituted or non-substituted aryl group (1-20 carbon atoms), and a substituted or non-substituted heterocyclic residue group (1-20 carbon atoms), including a case of R₁ and R₂ being mutually bonded to form a pyridine ring.

15. An electroluminescent device comprising:
an anode;
a cathode; and
an electroluminescent layer between the anode and the cathode,
wherein the electroluminescent layer is formed by co-deposition of an organic compound and a metal salt, and includes a metal complex having a structure represented by a following general formula (8): 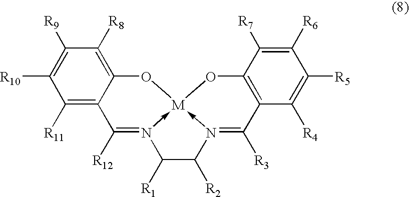
wherein M represents a saturated or unsaturated metal ion and R₁-R₁₅ each represents one of a hydrogen element, a halogen element, a cyano group, an alkyl group (1-10 carbon atoms), an alkoxyl group (1-10 carbon atoms), a substituted or non-substituted aryl group (1-20 carbon atoms), or a substituted and non-substituted heterocyclic residue group (1-20 carbon atoms), including cases of R₁ and R₂ being mutually bonded to form a cycloalkane structure, a benzene ring or poly-condensed rings (1 to 20 carbon atoms), R₄ and R₅, R₅ and R₆, R₆ and R₇, R₈ and R₉, R₉ and R₁₀ or R₁₀ and R₁₁ being mutually bonded to form a benzene ring or poly-condensed rings (1-20 carbon atoms), and R₂ and R₃ or R₁ and R₁₂ being mutually bonded to form a pyridine ring.

16. An electroluminescent device comprising:
an anode;
a cathode; and
an electroluminescent layer between the anode and the cathode,
wherein the electroluminescent layer is formed by co-deposition of an organic compound and a metal salt, and includes a metal complex having a structure represented by a following general formula (9): 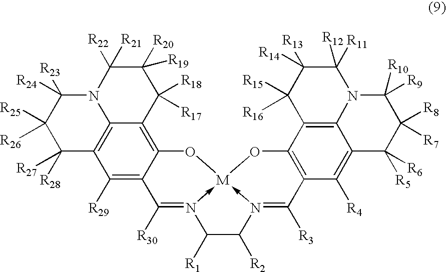
wherein M represents a saturated or unsaturated metal ion and R₁-R₃₀ each represents one of a hydrogen element, a halogen element, a cyano group, an alkyl group (1-10 carbon atoms), an alkoxyl group (1-10 carbon atoms), a substituted or non-substituted aryl group (1-20 carbon atoms), and a substituted or non-substituted heterocyclic residue group (1-20 carbon atoms), including cases of R₁ and R₂ being mutually bonded to form a cycloalkane structure, a benzene ring or poly-condensed rings (1 to 20 carbon atoms) and R₂ and R₃ or R₁ and R₃₀ being mutually bonded to form a pyridine ring.

17. An electroluminescent device comprising:
an anode;
a cathode; and
an electroluminescent layer between the anode and the cathode,
wherein the electroluminescent layer is formed by co-deposition of an organic compound and a metal salt, and includes a metal complex having a structure represented by a following general formula (10): 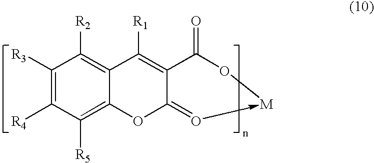
wherein M represents a saturated or unsaturated metal ion, R₁-R₅ each represents one of a hydrogen element, a halogen element, a cyano group, an alkyl group (1-10 carbon atoms), an alkoxyl group (1-10 carbon atoms), a substituted or non-substituted aryl group (1-20 carbon atoms), and a substituted or non-substituted heterocyclic residue group (1-20 carbon atoms), and n represents an integer from 1 to 4, including cases of R₄ representing one of an amino group, a dialkylamino group, and an arylamino group, R₂ and R₃, R₃ and R₄ or R₄ and R₅ being mutually bonded to form a benzene ring or poly-condensed rings (1 to 20 carbon atoms), and R₃ and R₄, or R₄ and R₅ being mutually bonded to form a julolidine skeleton.

18. The electroluminescent device according to any one of claims 13 to 17, wherein the saturated or unsaturated metal ion comprises one of zinc, aluminum, silicon, gallium and zirconium.

19. A method for manufacturing an electroluminescent device comprising at least an anode, a cathode and an electroluminescent layer between the anode and the cathode and including at least one organic compound layer, comprising the step of:
forming at least one of the organic compound layers comprising a step of co-depositing an organic compound including a proton-donating functional group showing Bronsted acid, a functional group having a non-covalent electron pair, and a metal salt.

20. The method for manufacturing the electroluminescent device according to claim 19, wherein the proton-donating functional group is one of a hydroxyl group, a carboxyl group and a mercapto group.

21. The method for manufacturing the electroluminescent device according to claim 19, wherein the functional group having the non-covalent electron pair is one of a heterocyclic residue group, an azomethine group and a carbonyl group.

22. The method for manufacturing the electroluminescent device according to claim 19, wherein the proton-donating functional group is one of a hydroxyl group, a carboxyl group and a mercapto group, and the functional group having the non-covalent electron pair is one of a heterocyclic residue group, an azomethine group and a carbonyl group.

23. The method for manufacturing the electroluminescent device according to claim 19, wherein the metal salt is one of a metal acetate salt, a metal halide and a metal alkoxide.

24. A method for manufacturing an electroluminescent device comprising at least an anode, a cathode and an electroluminescent layer between the anode and the cathode including at least one organic compound layer, comprising the step of:
forming at least one of the organic compound layers comprising a step of co-depositing an organic compound represented by a following general formula (1) and a metal salt: 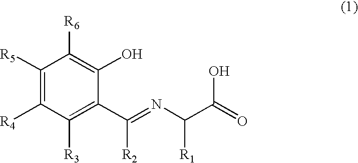
wherein R₁-R₆ each represents one of a hydrogen element, a halogen element, a cyano group, an alkyl group (1-10 carbon atoms), an alkoxyl group (1-10 carbon atoms), a substituted or non-substituted aryl group (1-10 carbon atoms), and a substituted or non-substituted heterocyclic residue group (1-20 carbon atoms), including the cases of R₃ and R₄, R₄ and R₅ or R₅ and R₆ being mutually bonded to form a benzene ring or poly-condensed rings (1-20 carbon atoms) and R₁ and R₂ being mutually bonded to form a pyridine ring.

25. A method for manufacturing an electroluminescent device comprising at least an anode, a cathode and an electroluminescent layer between the anode and the cathode including at least one organic compound layer, comprising the step of:
forming at least one of the organic compound layers comprising a step of co-depositing an organic compound represented by a following general formula (2) and a metal salt: 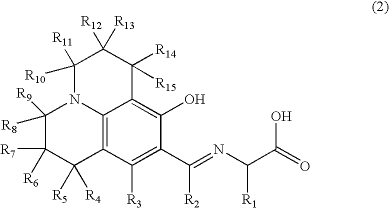
wherein R₁-R₁₅ each represents one of a hydrogen element, a halogen element, a cyano group, an alkyl group (1-10 carbon atoms), an alkoxyl group (1-10 carbon atoms), a substituted or non-substituted aryl group (1-20 carbon atoms), and a substituted or non-substituted heterocyclic residue group (1-20 carbon atoms), including a case of R₁ and R₂ being mutually bonded to form a pyridine ring.

26. A method for manufacturing an electroluminescent device comprising at least an anode, a cathode and an electroluminescent layer between the anode and the cathode including at least one organic compound layer, comprising the step of:
forming at least one of the organic compound layers comprising a step of co-depositing an organic compound represented by a following general formula (3) and a metal salt: 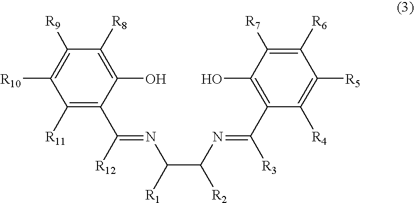
wherein R₁-R₁₂ each represents one of a hydrogen element, a halogen element, a cyano group, an alkyl group (1-10 carbon atoms), an alkoxyl group (1-10 carbon atoms), a substituted or non-substituted aryl group (1-20 carbon atoms), and a substituted or non-substituted heterocyclic residue group (1-20 carbon atoms), including cases of R1 and R2 being mutually bonded to form a cycloalkane structure, a benzene ring or poly-condensed rings (1 to 20 carbon atoms), R₄ and R₅, R₅ and R₆, R₆ and R₇, R₈ and R₉, R₉ and R₁₀ or R₁₀ and R₁₁ being mutually bonded to form a benzene ring or poly-condensed rings (1-20 carbon atoms), and R₂ and R₃ or R₁ and R₁₂ being mutually bonded to form a pyridine ring.

27. A method for manufacturing an electroluminescent device comprising at least an anode, a cathode and an electroluminescent layer between the anode and the cathode including at least one organic compound layer, comprising the step of:
forming at least one of the organic compound layers comprising a step of co-depositing an organic compound represented by a following general formula (4) and a metal salt: 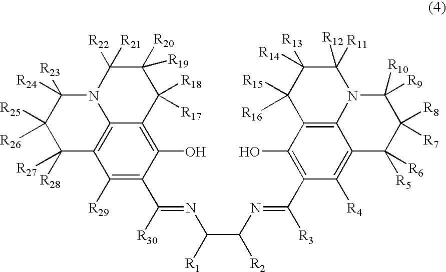
wherein R₁-R₃₀ each represents one of a hydrogen element, a halogen element, a cyano group, an alkyl group (1-10 carbon atoms), an alkoxyl group (1-10 carbon atoms), a substituted or non-substituted aryl group (1-20 carbon atoms), and a substituted or non-substituted heterocyclic residue group (1-20 carbon atoms), including cases of R₁ and R₂ being mutually bonded to form a cycloalkane structure, a benzene ring or poly-condensed rings (1 to 20 carbon atoms) and R₂ and R₃ or R₁ and R₃₀ being mutually bonded to form a pyridine ring.

28. A method for manufacturing an electroluminescent device comprising at least an anode, a cathode and an electroluminescent layer between the anode and the cathode including at least one organic compound layer, comprising the step of:
forming at least one of the organic compound layers comprising a step of co-evaporating an organic compound represented by a following general formula (5) and a metal salt: 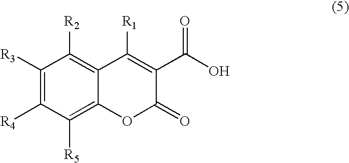
wherein R₁-R₅ each represents one of a hydrogen element, a halogen element, a cyano group, an alkyl group (1-10 carbon atoms), an alkoxyl group (1-10 carbon atoms), a substituted or non-substituted aryl group (1-20 carbon atoms), and a substituted or non-substituted heterocyclic residue group (1-20 carbon atoms), including cases of R₄ representing one of an amino group, a dialkylamino group, and an arylamino group, R₂ and R₃, R₃ and R₄ or R₄ and R₅ being mutually bonded to form a benzene ring or poly-condensed rings (1 to 20 carbon atoms), and R₃ and R₄, or R₄ and R₅ being mutually bonded to form a julolidine skeleton.

29. The method for manufacturing the electroluminescent device according to any one of claims 24 to 28, wherein the metal salt is one of a metal acetate salt, a metal halide and a metal alkoxide.

30. The method for manufacturing the electroluminescent device according to any one of claims 24 to 28, wherein the metal salt includes one of zinc, aluminum, silicon, gallium and zirconium.
